(19) United States
(12) Patent Application Publication
(10) Pub. No.: US 2014/0340582 A1
(43) Pub. Date: Nov. 20, 2014

(54) Method of ATSC MH Stream Assisted Channel Characterization for Mobile ATSC TV Receiver

(71) Applicant: Lin Yang, Milpitas, CA (US)

(72) Inventor: Lin Yang, Milpitas, CA (US)

(21) Appl. No.: 13/896,191

(22) Filed: May 16, 2013

(51) Int. Cl. H04N 5/44; H04N 17/04

(52) U.S. Cl. CPC H04N 5/4401; H04N 17/04
USPC 348/731; 348/725

(57) ABSTRACT

This invention is a method to quickly characterize the time variant channel state information to enable ATSC HDTV signal reception in a mobile environment (e.g. in a moving car, walking, on a bus, etc.) by removing the Doppler interference. The invention relates to a single or multiple antenna ATSC terrestrial DTV receiver for indoor and mobile users.

### TECHNICAL FIELD

The present invention relates generally to an application in a digital television system, more specifically the present invention relates to a single or multiple antenna ATSC terrestrial TV receivers for indoor and mobile users.

### BACKGROUND

Traditionally, terrestrial ATSC HDTV programming can only be viewed on a TV console in a fixed or static environment (e.g. family room).

Today, mobile devices with screens are ubiquitous. Examples include, but are not limited to; laptops, tablets, cell phones, car infotainment systems, etc. However, terrestrial ATSC HDTV programming cannot be viewed on these devices in a mobile environment. This is because existing ATSC HDTV receivers cannot have stable reception in a mobile environment due to the Doppler interference caused by mobile conditions.

The new updated ATSC standard for ATSC Mobile/Handheld is called ATSC A153. This standard will address the Doppler interference issue only for low-resolution display devices. The ATSC A153 system is described in FIG. 3.

However, for high definition/high resolution TV reception, in order to remove the Doppler interference caused by mobile conditions, a method to quickly estimate the terrestrial ATSC HDTV transmission channel characteristics is needed.

The following patents are herein incorporated by reference: U.S. patent application Ser. No. 12/512,901 entitled A NOVEL EQUALIZER FOR SINGLE CARRIER TERRESTRIAL DTV RECEIVER, by Yang; U.S. patent application Ser. No. 12/554,925 entitled A MULTIPLE TUNER ATSC TERRESTRIAL RECEIVER FOR INDOOR & MOBILE USERS, by Yang; U.S patent application Ser. No. 12/572,236 entitled A MULTIPLE TUNER TERRESTRIAL DTV RECEIVER FOR INDOOR & MOBILE USERS, by Yang; U.S. patent application Ser. No. 13/871,869 entitled WI-FI ATSC TV ANTENNA, by Yang; U.S. patent application Ser. No. 13/872,917 entitled MULTIPLE ANTENNA ATSC HDTV RECEIVER DEVICE, by Yang; U.S. patent application Ser. No. 13/889,158 entitled A METHOD OF CHANNEL CHARACTERIZATION FOR MOBILE ATSC HDTV RECEIVER, by Yang.

The prior art made of record and not relied upon are hereupon disclosed: United States patent number 20100273427, by Mergen, which discloses a method and apparatus for filtering noisy estimates to reduce estimation errors; and United States patent number 20130114767, by Lee, which shows an apparatus and method for enhancing channel estimation accuracy in communication systems.

In addition to the above-referenced applications, the present invention adds the following functions: The function of ATSC Legacy System Field Sync Symbol and ATSC Mobile / Handheld System Known Symbol Extractor and the function of the Channel State Information Prediction Kalman Filter.

### SUMMARY OF INVENTION

This invention is a method to quickly estimate the terrestrial ATSC HDTV transmission channel characteristics in order to remove the Doppler interference present in a mobile situation.

### BRIEF DESCRIPTION OF DRAWINGS

Having thus described the invention in general terms, reference will now be made to the accompanying drawings, which are not necessarily drawn to scale, and wherein:

FIG. 1 shows an example of A Terrestrial ATSC HDTV Receiver.

FIG. 2 shows the ATSC MH Stream Assisted Channel State Information Estimator & Signal-To-Noise Ratio Estimator.

FIG. 3 shows the ATSC A153 Terrestrial TV System.

FIG. 4 shows a single antenna being coupled to a single tuner.

FIG. 5 shows a single antenna being coupled to a plurality of tuners.

FIG. 6 shows a plurality of antennas being coupled to a plurality of tuners.

FIG. 7 shows a single Wi-Fi ATSC TV antenna.

FIG. 8 shows a plurality of Wi-Fi ATSC Antennas.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

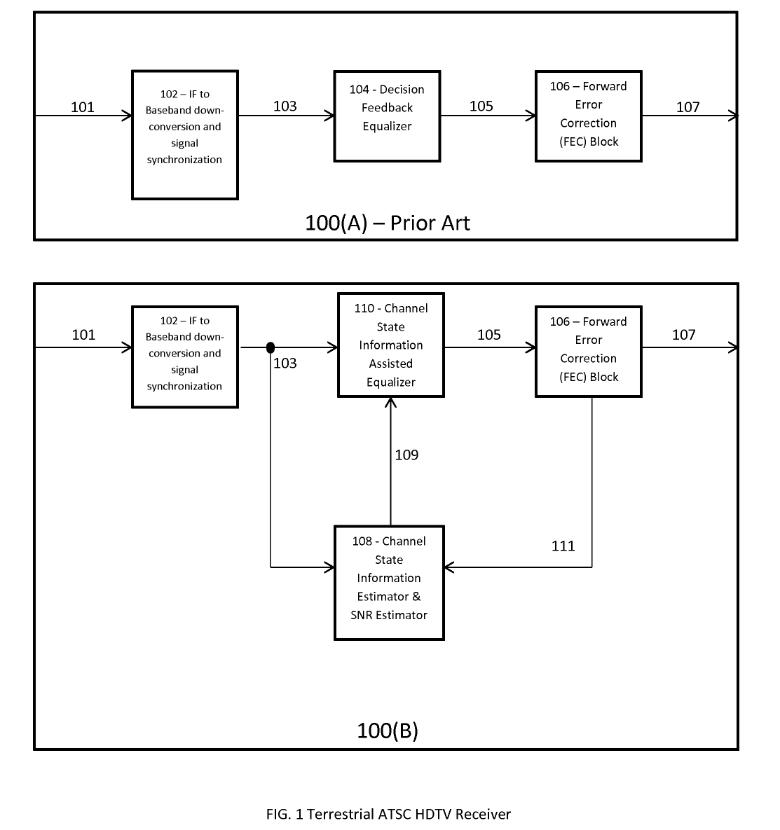

### FIG. 1

100—Terrestrial ATSC TV Receiver (an example)

101—Digital ATSC IF Signal

102—IF to Baseband down-conversion and signal synchronization. Includes but not limited to frequency shifting, low-pass filter, symbol timing recovery, carrier recovery, SRRC filter, Field Synchronization, segment synchronization

103—Synchronized baseband ATSC TV signal

104—Decision Feedback Equalizer

105—Demodulated ATSC TV Signal

106—Forward Error Correction (FEC) Block: includes Viterbi Decoder, De-interleaver, R.S. Decoder, and De-randomizer

107—MPEG TS (Transport Stream)

108—Channel State Information Estimator & SNR (Signal-To-Noise Ratio) Estimator

109—Channel State Information

110—Channel State Information Assisted Equalizer

111—Decoded ATSC TV Signal

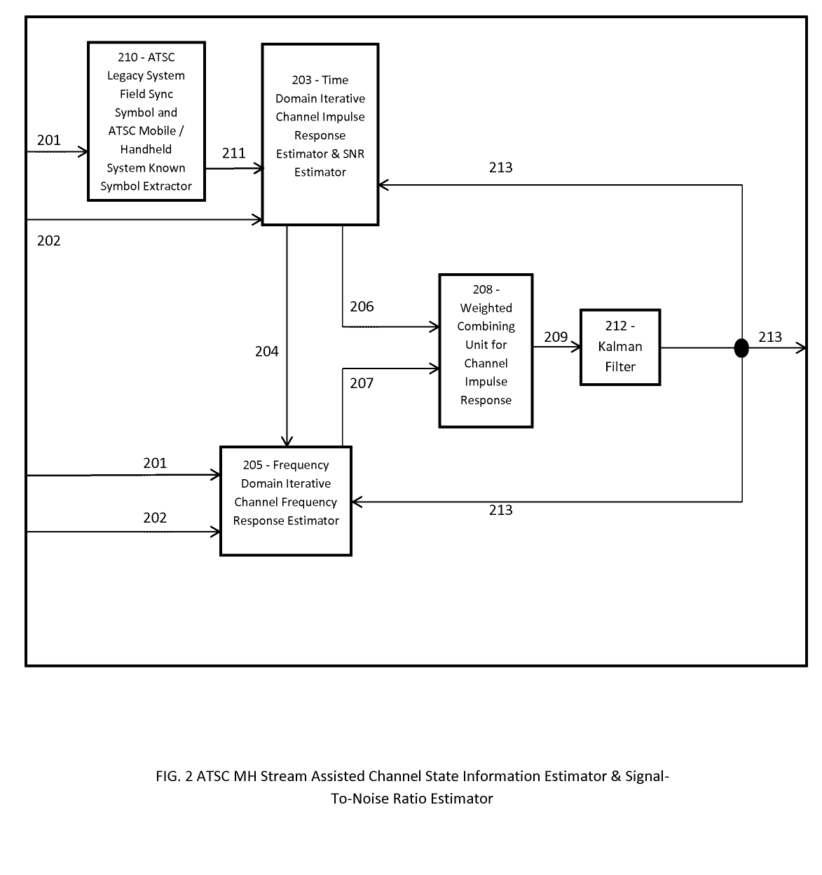

### FIGS. 2—108

201 (also 103 in FIG. 1)—Synchronized baseband ATSC TV signal

202 (also 111 in FIG. 1)—Decoded ATSC TV Signal

203—Time Domain Iterative Channel Impulse Response Estimator & SNR Estimator

204—Initial Channel Impulse Response

205—Frequency Domain Iterative Channel Frequency Response Estimator

206—Channel Impulse Response and SNR

207—Channel Impulse Response

208—Weighted Combining Unit for Channel Impulse Response

209—Weighted Channel Impulse Response and SNR

210—ATSC Legacy System Field Sync Symbol and ATSC Mobile/Handheld System Known Symbol Extractor

211—ATSC Legacy System Field Sync and ATSC Mobile/Handheld System Known Symbol

212—Kalman Filter

213—(also 109 in FIG. 1)—Channel State Information

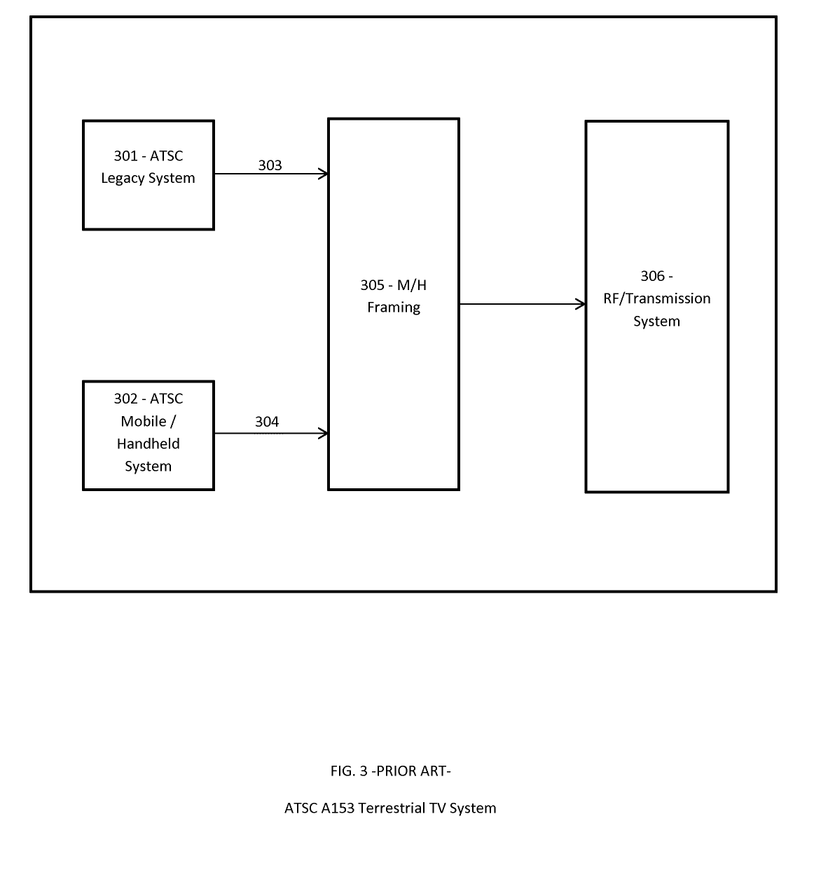

### FIG. 3—PRIOR ART—ATSC A153 Terrestrial TV System

301—ATSC Legacy System

302—ATSC Mobile/Handheld System

303—MPEG 2 Transport

304—IP Transport

305—M/H Framing

306—RF/Transmission System

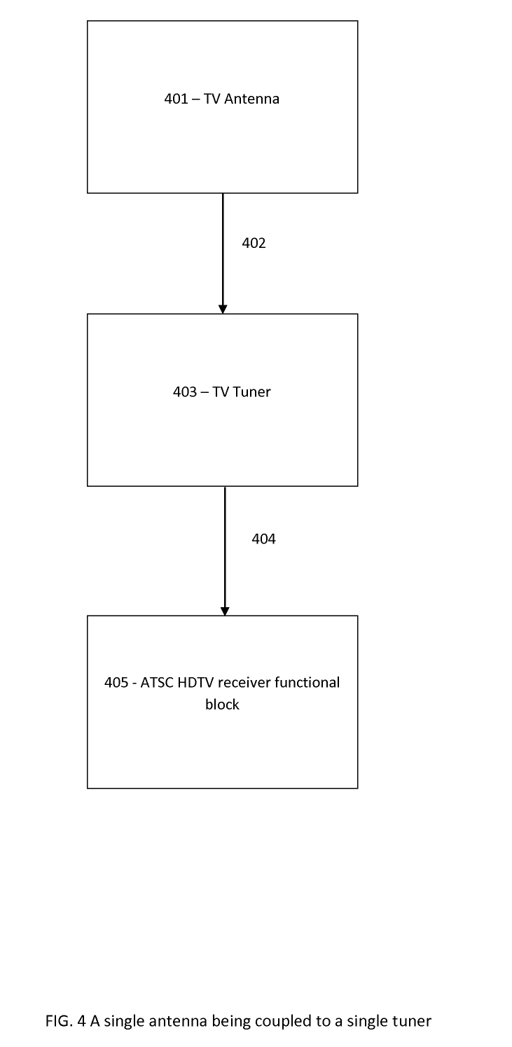

### FIG. 4

401—TV Antenna

402—Wired Connection

403—TV Tuner

404 (also 101 in FIG. 1)—Digital ATSC IF Signal

405 (also 100B in FIG. 1)—ATSC HDTV receiver functional block

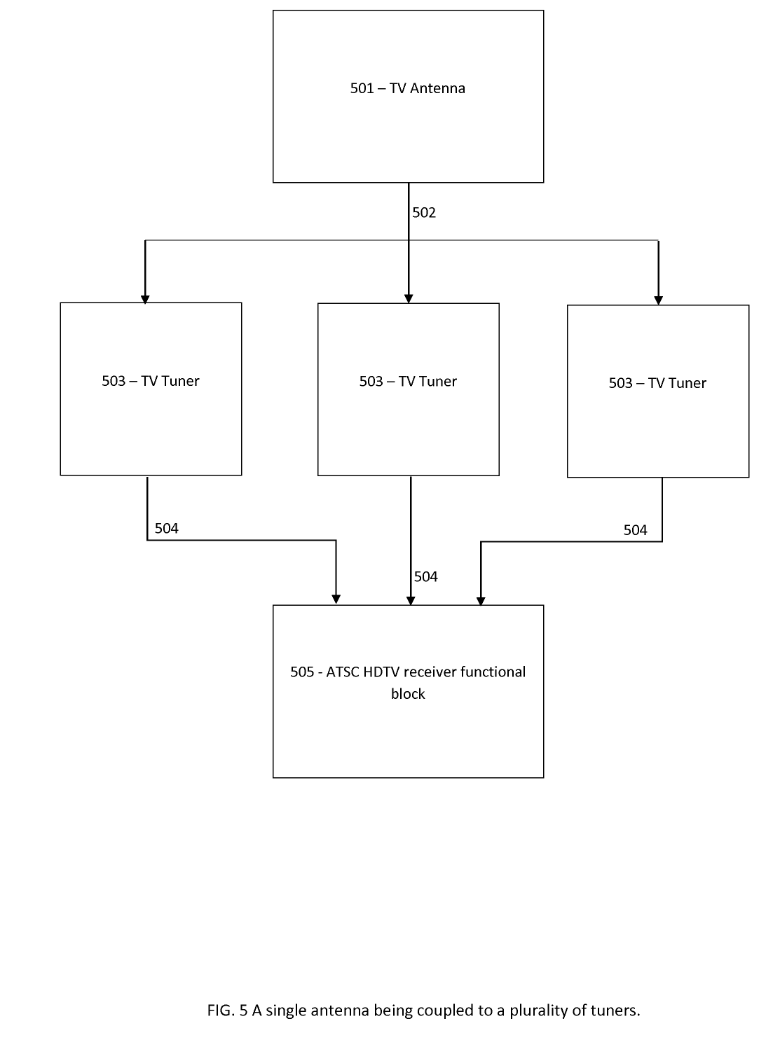

### FIG. 5

501—TV Antenna

502—Wired Connection

503—TV Tuner

504 (also 101 in FIG. 1)—Digital ATSC IF Signal

505 (also 100B in FIG. 1)—ATSC HDTV receiver functional block

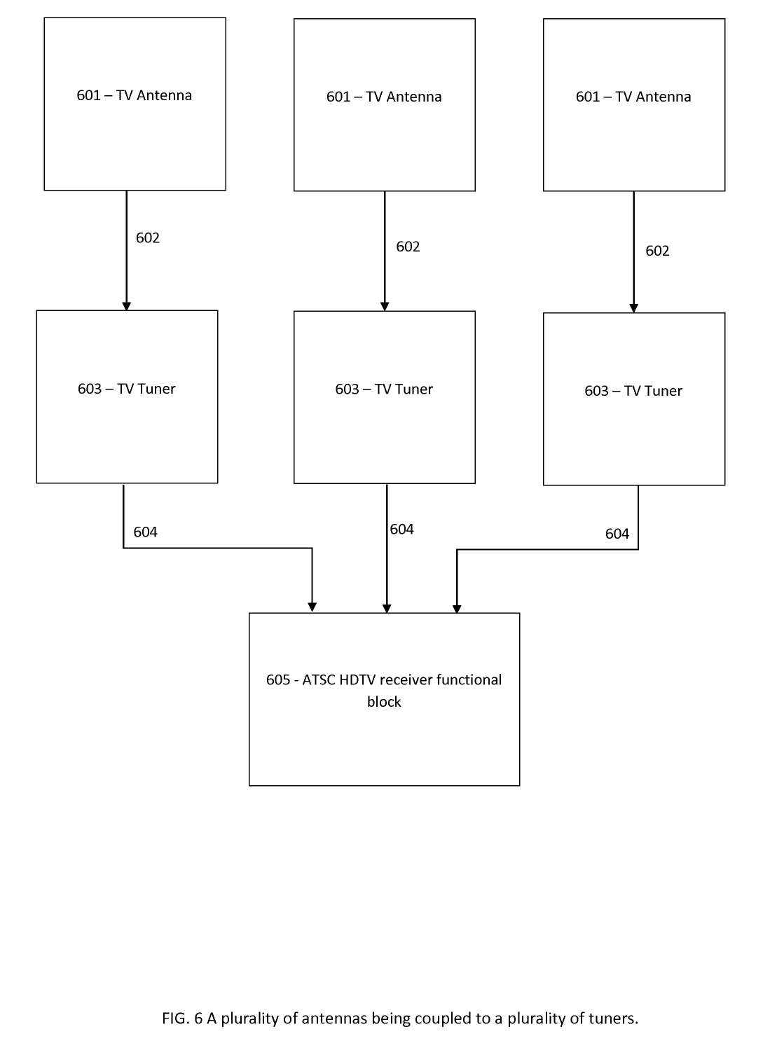

### FIG. 6

601—TV Antenna

602—Wired Connection

603—TV Tuner

604 (also 101 in FIG. 1)—Digital ATSC IF Signal

605 (also 100B in FIG. 1)—ATSC HDTV receiver functional block

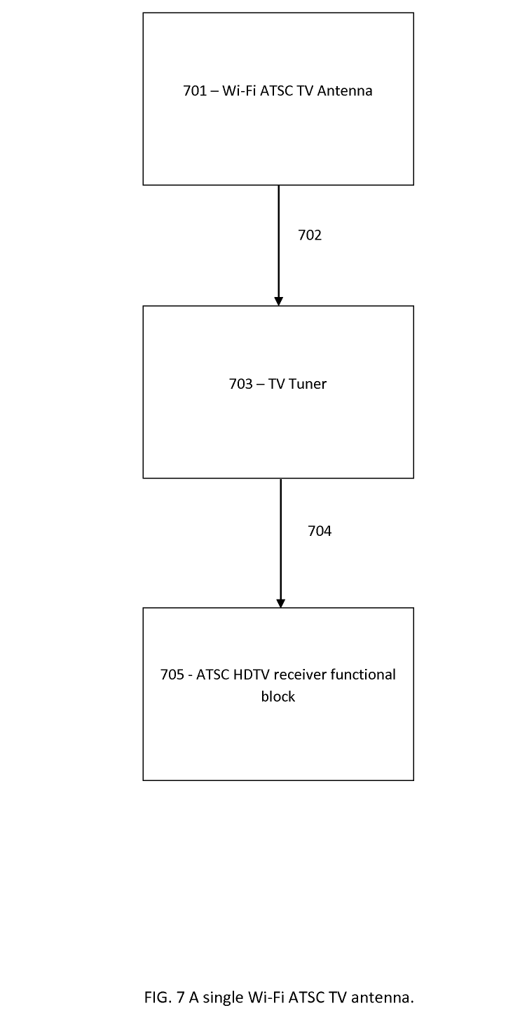

### FIG. 7

701—Wi-Fi ATSC TV Antenna

702—Wi-Fi Connection

703—TV Tuner

704 (also 101 in FIG. 1)—Digital ATSC IF Signal

705 (also 100B in FIG. 1)—ATSC HDTV receiver functional block

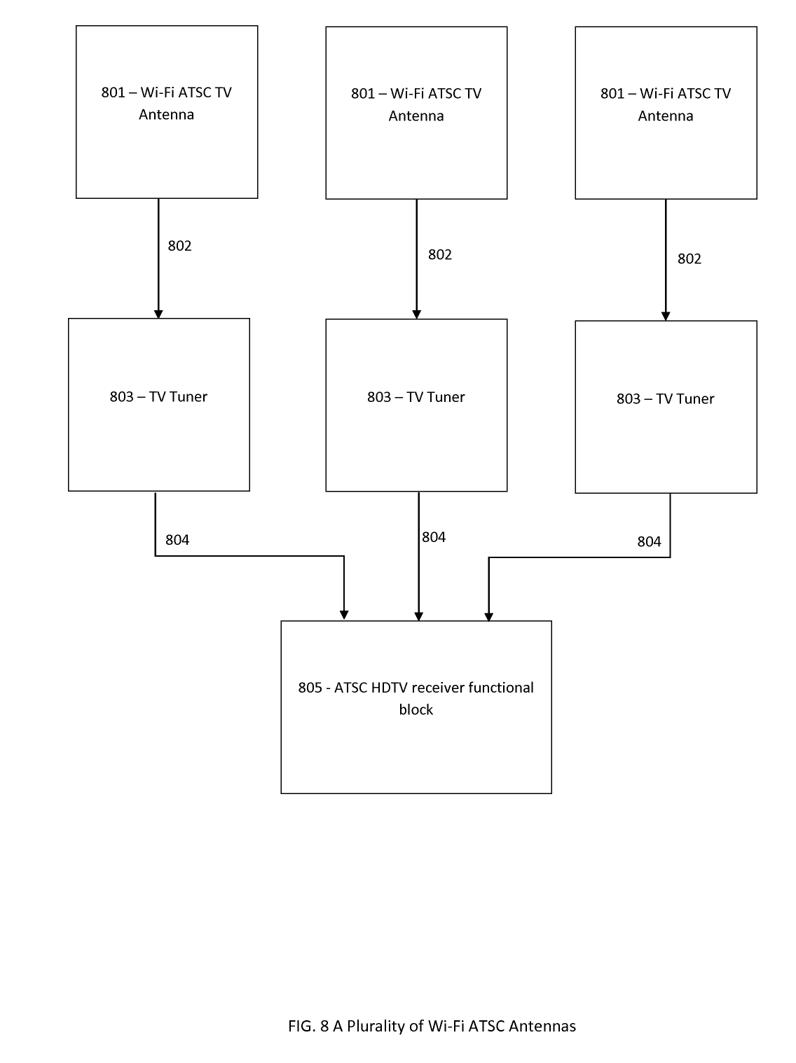

### FIG. 8

801—Wi-Fi ATSC TV Antenna

802—Wi-Fi Connection

803—TV Tuner

804 (also 101 in FIG. 1)—Digital ATSC IF Signal

805 (also 100B in FIG. 1)—ATSC HDTV receiver functional block

FIG. 1(A) is an example of a traditional ATSC TV receiver functional block diagram.

The digital ATSC IF Signal (101) goes in to the functional block (102) which performs the following functions: IF to Baseband down-conversion and signal synchronization. Includes but not limited to frequency shifting, low-pass filter, symbol timing recovery, carrier recovery, SRRC filter, Field Synchronization, and segment synchronization.

The output of functional block (102) is a synchronized baseband ATSC TV signal (103), which goes in to a decision feedback equalizer (104). The demodulated ATSC TV Signal (105) from the decision feedback equalizer (104) goes in to the Forward Error Correction Block (106), which performs the following functions: Viterbi Decoder, De-interleaver, R.S. Decoder, and De-randomizer, and then generates the MPEG TS (107).

FIG. 1(B) is an example of a new ATSC TV receiver functional block diagram applying this invention.

The invention replaces the traditional decision feedback equalizer (104) in FIG. 1(A) with the Channel State Information Estimator & SNR Estimator (108) and Channel State Information Assisted Equalizer (110).

The channel state information (109) is generated from the Channel State Information Estimator & SNR Estimator (108) based on the synchronized baseband ATSC TV signal (103) and the decoded ATSC HDTV signal (111).

FIG. 2 is the ATSC MH Stream Assisted Channel State Information Estimator & Signal-To-Noise Ratio Estimator.

The ATSC field-sync sequence of the ATSC Legacy System signal and the known symbol of the ATSC Mobile/Handheld System (211) are extracted by the ATSC Legacy System Field Sync Symbol and ATSC Mobile/Handheld System Known Symbol Extractor (210) from the Synchronized baseband ATSC TV signal (201).

The ATSC field-sync sequence of the ATSC Legacy System signal and the known symbol of the ATSC Mobile/Handheld System (211) and the decoded ATSC TV signal (202) go in to the Time Domain Iterative Channel Impulse Response Estimator in (203) to initialize and update the channel impulse response (204). The Time Domain Iterative Channel Impulse Response Estimator in (203) is using either the Least Means Square (LMS) or the Recursive Least Square (RLS) algorithm. The channel impulse response of (209) is time variant in mobile environments. Therefore, (203) is using previously estimated channel impulse response (209) as a reference to iteratively update the time variant channel impulse response. Because of the time variant nature of the channel impulse response in the mobile ATSC TV reception environment, a decoded ATSC TV signal (203) must be used in between the field sync signals in (201).

The output of the Time Domain Iterative Channel Impulse Response Estimator & SNR Estimator (203) is Channel Impulse Response and SNR (206), which goes to Weighted Combining of Channel Impulse Response (208).

The output of 208, the Weighted Channel Impulse Response and SNR (209), goes to the Kalman Filter (212), which predicts the current channel state information by using the statistics of the past dynamic channel state information.

Optionally, in addition to using a Time Domain Iterative Channel Impulse Response Estimator & SNR Estimator (203), a Frequency Domain Iterative Channel Frequency Response Estimator (205) can be used, given the initial channel impulse response (204).

In the Frequency Domain Iterative Channel Frequency Response Estimator (205), the following algorithm is used:
1. Zero padding guard interval data segment reference signal generation
2. Pre-segment and post-segment data removal of the Synchronized baseband ATSC TV signal (201) for each segment
3. Fast Fourier Transform (FFT) and Inverse Fast Fourier Transform (IFFT) are used to do the transformation between channel impulse response and frequency response

The output channel impulse response (207) is generated from Frequency Domain Iterative Channel Frequency Response Estimator (205) and fed in to the Weighted Combining Unit for Channel Impulse Response (208).

The output of 208, the Weighted Channel Impulse Response and SNR (209), goes to the Kalman Filter (212), which predicts the current channel state information by using the statistics of the past dynamic channel state information.

The output of the Kalman Filter (212) is the channel state information (213), which is a combined channel impulse response and SNR for each signal segment.

FIG. 3—PRIOR ART—shows a reference system for the ATSC A153 Terrestrial TV Broadcasting Standard.

FIG. 4 shows a single antenna being coupled to a single tuner. A single TV Antenna (401) connects to a single TV Tuner (403) by a wired connection (402). The TV Tuner (403) outputs a Digital ATSC IF Signal (404) to the ATSC HDTV receiver functional block (405).

FIG. 5 shows a single antenna being coupled to a plurality of tuners. A single TV Antenna (501) connects to a plurality of TV Tuners (503) by wired connections (502). The TV Tuner (503) outputs a Digital ATSC IF Signal (504) to the ATSC HDTV receiver functional block (505).

FIG. 6 shows a plurality of antennas being coupled to a plurality of tuners. A plurality of TV Antennas (601) connects to a plurality of TV Tuners (603) by wired connections (602). The TV Tuner (603) outputs a Digital ATSC IF Signal (604) to the ATSC HDTV receiver functional block (605).

FIG. 7 shows a single Wi-Fi ATSC TV antenna. The Wi-Fi ATSC TV Antenna (701) is connected to the TV Tuner (703) using a Wi-Fi connection (702). The TV Tuner (703) outputs a Digital ATSC IF Signal (704) to the ATSC HDTV receiver functional block (705).

FIG. 8 shows a Plurality Wi-Fi ATSC Antennas. A plurality of Wi-Fi ATSC TV Antennas (801) is connected to a plurality of TV Tuners (803) using Wi-Fi connections (802). The TV Tuner (803) outputs a Digital ATSC IF Signal (804) to the ATSC HDTV receiver functional block (805).

What is claimed is:

1. A method of terrestrial ATSC HDTV signal reception using both the ATSC Legacy System Field Sync Symbol and ATSC Mobile/Handheld System Known Symbol Extractor to estimate the ATSC TV broadcasting signal propagation characteristics in the mobile environment using the following functions:
a. The function of Time Domain Iterative Channel Impulse Response Estimator & Signal-To-Noise Ratio Estimator, and
b. The function of Frequency Domain Iterative Channel Frequency Response Estimator, and
c. The function of Weighted Combining Unit for Channel Impulse Response, and
d. The function of Kalman Filter to predict the next embedded signal using the estimated signal propagation characteristics.

2. The method of claim 1 is associated with a single antenna being coupled to a single tuner.

3. The method of claim 1 is associated with a single antenna being coupled to a plurality of tuners.

4. The method of claim 1 is associated with a plurality of antennas being coupled to a plurality of tuners.

5. The method of claim 1 is associated with a single Wi-Fi ATSC TV antenna.

6. The method of claim 1 is associated with a plurality of Wi-Fi ATSC TV antennas.
